(19) United States
(12) Patent Application Publication
(10) Pub. No.: US 2004/0093408 A1
(43) Pub. Date: May 13, 2004

(54) IT asset tracking system

(76) Inventors: Harikrishin W. Hirani, Los Altos, CA (US); Vallinayagam R. Nallaperumal, San Jose, CA (US); Ashish Nigam, Santa Clara, CA (US); Jalil Ahmed, San Jose, CA (US); Sung Y. Kwon, Redwood City, CA (US)

Correspondence Address: Saina S. Shamilov, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/290,869

(22) Filed: Nov. 8, 2002

(51) Int. Cl. G06F 15/173

(52) U.S. Cl. 709/224

(57) ABSTRACT

A method and apparatus for IT asset tracking are disclosed. Information about assets connected to a network is discovered utilizing protocols compatible with the assets. The information is transmitted and status data for the network devices is maintained based on the discovered information.

### FIELD OF THE INVENTION

The present invention pertains to the field of automated tracking of networked assets. More particularly, the present invention relates to Information Technology (IT) assets tracking.

### BACKGROUND OF THE INVENTION

Large enterprise network owners are faced with a problem of obtaining as much information as possible about-information technology (IT) assets present in the network in order to efficiently manage the network. Financial management of networks involves determining which assets need to be upgraded or replaced, which assets include unauthorized hardware components, which assets are not necessary anymore and thus maintenance agreements with vendors should not be maintained for these assets. In order to be able to make these determinations efficiently, IT department operators need to have complete information about assets that are present in the network.

Present IT assets discovery solutions do not provide IT department operators with complete and accurate IT asset discovery. Most of the solutions discover at most 80% of the assets present in the network. In addition, not all the solutions are able to track asset locations and provide operators with information indicating for how long a particular asset was not connected to the network. Knowing which assets are not utilized and may be redeployed allows the network owners to save money by not purchasing equipment that they already own. In addition, not knowing which assets are being utilized in the network causes network owners to continue paying fees under maintenance contracts when in fact the assets do not need to be maintained.

What is needed, therefore, is a solution that overcomes these and other shortcomings of the prior art.

### SUMMARY OF THE INVENTION

The present invention includes a method and apparatus for tracking IT assets. The method includes discovering information about assets connected to a network, utilizing protocols compatible with the assets. The method may also include transmitting the discovered information and maintaining status data for the assets based on the discovered information.

### BRIEF DESCRIPTION OF THE DRAWINGS

The present invention is illustrated by way of example and not limitation in the figures of the accompanying drawings, in which like references indicate similar elements and in which:

FIG. 1 illustrates a network environment in which a tracking system may discover network devices connected to the network according to one embodiment of the present invention;

FIG. 2 illustrates components of the tracking system according to one embodiment of the present invention;

FIG. 3 illustrates components of databases according to one embodiment of the present invention;

FIG. 4 illustrates a network environment including subnets according to one embodiment of the present invention;

FIG. 5 is a flow diagram of assets discovery process according to one embodiment of the present invention;

FIG. 6 illustrates components of the tracking manager according to one embodiment of the present invention;

FIG. 7 illustrates enterprise created rules according to one embodiment of the present invention;

FIG. 8 illustrates a processing system according to one embodiment of the present invention;

FIG. 9 illustrates a graphical status report according to one embodiment of the present invention; and

FIG. 10 illustrates a status report according to one embodiment of the present invention.

### DETAILED DESCRIPTION

A method and apparatus for tracking IT assets are described. Note that in this description, references to “one embodiment” or “an embodiment” mean that the feature being referred to is included in at least one embodiment of the present invention. Further, separate references to “one embodiment” in this description do not necessarily refer to the same embodiment; however, neither are such embodiments mutually exclusive, unless so stated and except as will be readily apparent to those skilled in the art. Thus, the present invention can include any variety of combinations and/or integrations of the embodiments described herein.

The present invention discloses a method and system for tracking IT assets in an enterprise environment. Assets are discovered and periodically monitored in order to maintain a detailed history of utilization of assets in an enterprise network.

The term “enterprise”, as used herein, means a public, private or government entity, such as a corporation or company, which comprises information technology assets that need to be tracked. The term “IT assets”, as used herein, means PCs, laptops, routers, printers and the like, that were connected to the enterprise network at least at one point in time. The term “enterprise network”, as used herein, means a network of the enterprise including its subnets. The term “subnet”, as used herein, means a separate geographic location of the network. The terms “device” and “assets” are used interchangeably and mean, as used herein, any device/asset capable of being connected to a network.

Network-Based Related Technology

Some introduction to network-based technology may be helpful in understanding certain aspects of the invention.

One embodiment of the invention utilizes Packet Internet Groper (Ping). Ping is a utility associated with Transmission Control Protocol/Internet Protocol (TCP/IP) networks. Ping is the equivalent to yelling a person's name in an assembly and listening for their acknowledgement. A host pings another host on the network to determine if that host is reachable from the first host. The ping command takes the form ping ipaddress, where ipaddress is the numeric Internet Protocol (IP) address of the host to be contacted. Ping uses Internet Control Message Protocol (ICMP) for its operation. Specifically, it sends an ICMP echo request message to the designated host. If the device is reachable before a timeout period, the sending host will receive an ICMP echo reply message.

One embodiment of the invention utilizes Simple Network Management Protocol (SNMP), which is a set of protocols for network management. Data is sent to an SNMP agents, which are hardware and/or software processes reporting activity in each network device, such as a hub, router, bridge, to a workstation console used to oversee the network, usually at the Network Operating Center (NOC). The agents return information contained in its Management Information Base (MIB). The MIB is a data file that contains a complete collection of all the objects that are managed in a network. Objects are variables that hold information about the state of some processes running on a device or that include textual information about the device, such as a name and description. A particular device may have many objects that describe it. An SNMP agent runs in each SNMP-enabled device in a network and is responsible for updating object variables, which can be queried by the management system. There are groups of SNMP objects, such as System, Interface, IP, TCP. A MIB group called “System” contains objects that hold variables such as name of a device, its location, etc. An Interface MIB group comprises information about network adapters and tracks statistics such as bytes sent and received on the interface. The IP group has objects that track IP flow, dropped packets, etc. The TCP group has objects that keep track of connections.

Yet, another embodiment of the invention utilizes Media Access Control (MAC) addresses. MAC layer provides an interface between a Logical Link Control (LLC) layer and a particular network medium that is in use, such as Ethernet, token ring, etc. The MAC layer frames data for transmission over the network, and then passes the frame to the physical layer interface where it is transmitted as a stream of bits. A network interface card, such as an Ethernet adapter, has a unique MAC address programmed at the factory. This address follows an industry standard that ensures that no other adapter has a similar address. Therefore, workstations connected to a network will be uniquely identified for sending and receiving IP packets.

Another component utilized by an embodiment of the invention is NetBios. NetBios is a protocol of Windows Operating System provided by Microsoft Corporation (Redmond, Wash.). NetBios computers are identified by a unique 15-character name, and Windows machines, i.e. NetBios machines, periodically broadcast their names over the network. For TCP/IP networks, NetBios names are turned into IP addresses.

In addition, an embodiment of the invention utilizes Windows Management Instrumentation (WMI). This instrumentation in the networked devices, supports configuration and management. This instrumentation is built-in into Microsoft Corporations' newer operating systems; such as Window 2000 and XP.

Exemplary Architecture

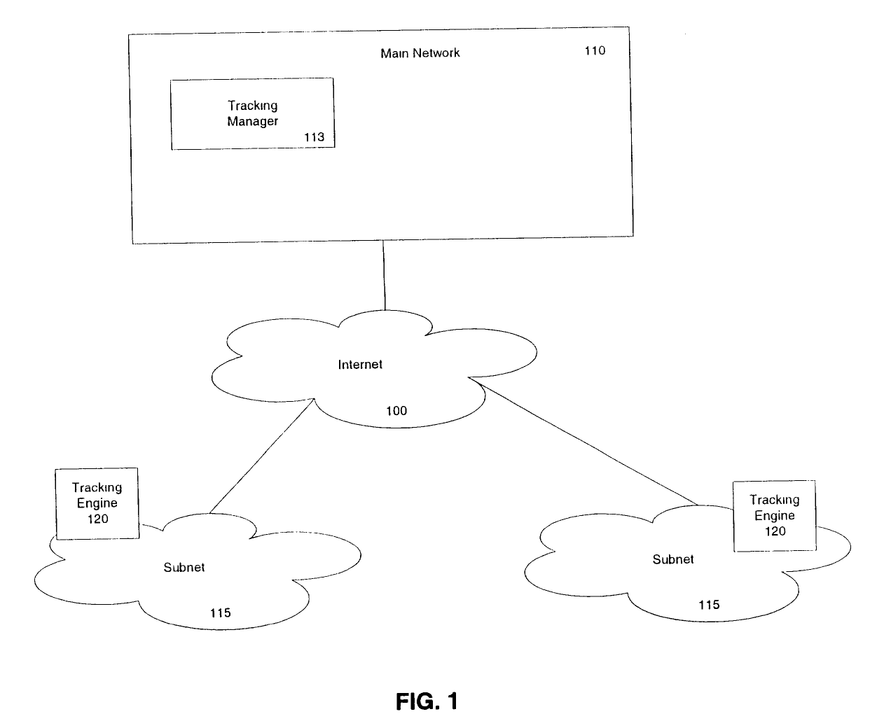

FIG. 1 illustrates an exemplary network environment in which the described method and apparatus can be implemented. A main network 110 is connected to the Internet 100. The main network 110 includes a tracking manager 113. The tracking manager 113 constitutes a component of a tracking system that will be described in detail below. The main network 110 and subnets 115 constitute an enterprise network defined above. Each subnet 115 includes a tracking engine 120, which is also a component of the tracking system. As defined above, subnets are enterprise sub-networks distributed over a geographic area. As illustrated in FIG. 1, the subnets 115 are also connected to the Internet 100. The subnets 115 may include firewalls (not shown) in order to keep networks secure from intruders.

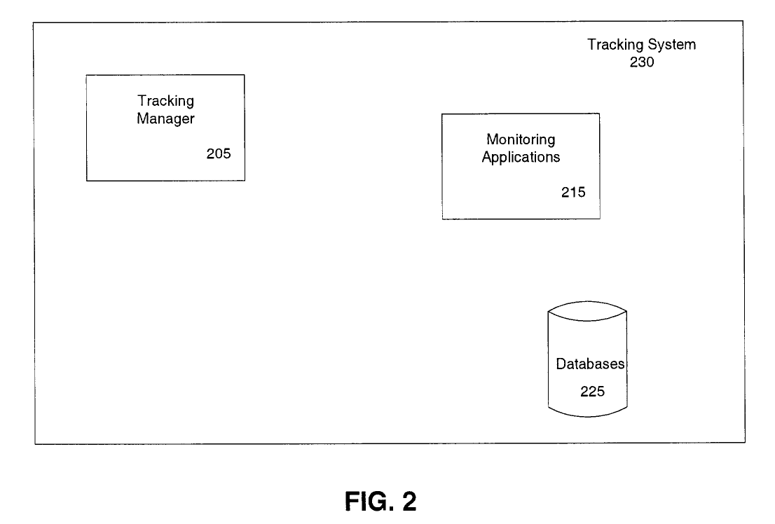

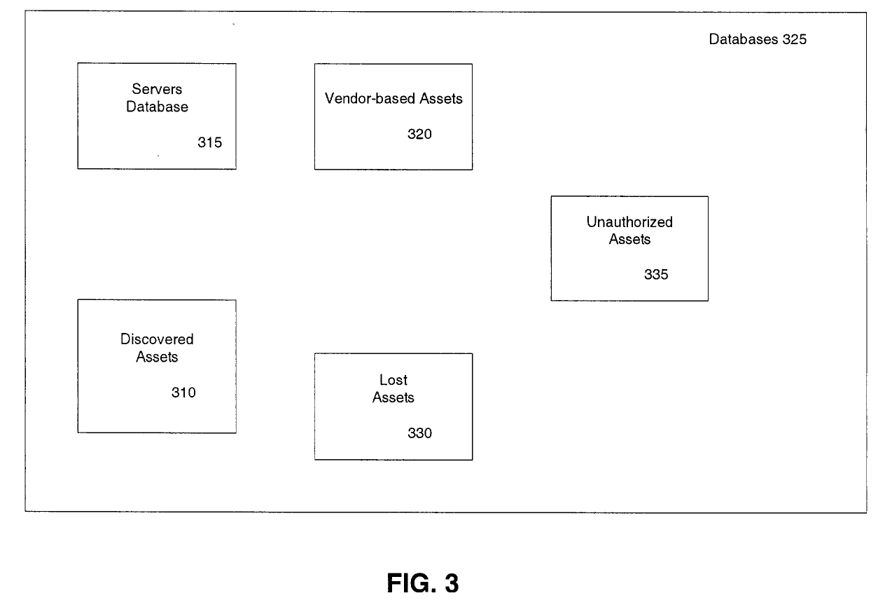

FIG. 2 illustrates components of the tracking system 230 located on the main network according to one embodiment of the invention. It will be appreciated that the term “main network” is utilized here for ease of understanding the invention. The components of the tracking system 230 may be located on one or several server machines of the enterprise network. The illustrated tracking system components include a tracking manager 205 to maintain databases of information associated with IT assets present at least at one point in time in the enterprise network. Monitoring applications 215 is another component of the tracking system 230. Functions of the monitoring applications 215 will be apparent from the discussion that follows. The tracking system 210 also comprises databases 225 to store asset monitoring information and asset status report information. FIG. 3 illustrates components of the databases 225. In one embodiment the databases 225 include discovered assets database 310, vendor-based assets database 320, unauthorized assets database 335, lost assets database 330. It will be noted that a single database may be used to store the information as well and the present invention is not limited to the databases listed above. Functions of these databases will be apparent from the following discussion.

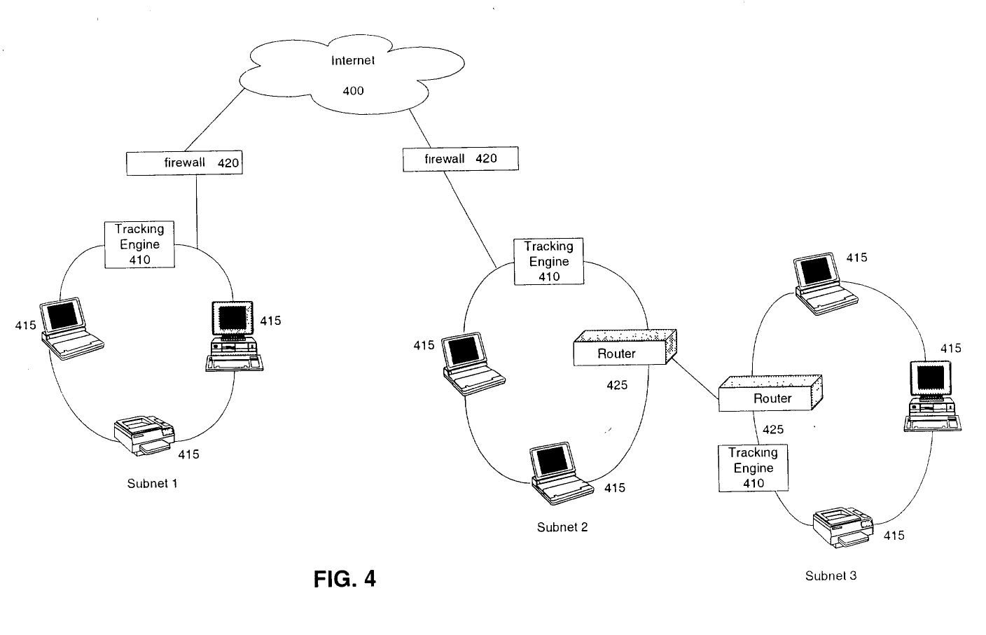

FIG. 4 illustrates enterprise subnets according to one embodiment of the invention. As illustrated in FIG. 4 a subnet comprises several IT assets 415, that may be printers, personal computers, laptops, network equipment, such as routers, bridges, etc. Subnets may also include a Virtual Private Network (VPN) gateway to track assets utilized by remote users. In addition, subnets comprise a tracking engine 410. Subnets that are connected via routers 425 may comprise one tracking engine 410, i.e. there may be one tracking engine per one firewall 420 in the enterprise network. Details of these and other components of the invention will be apparent from the following discussion.

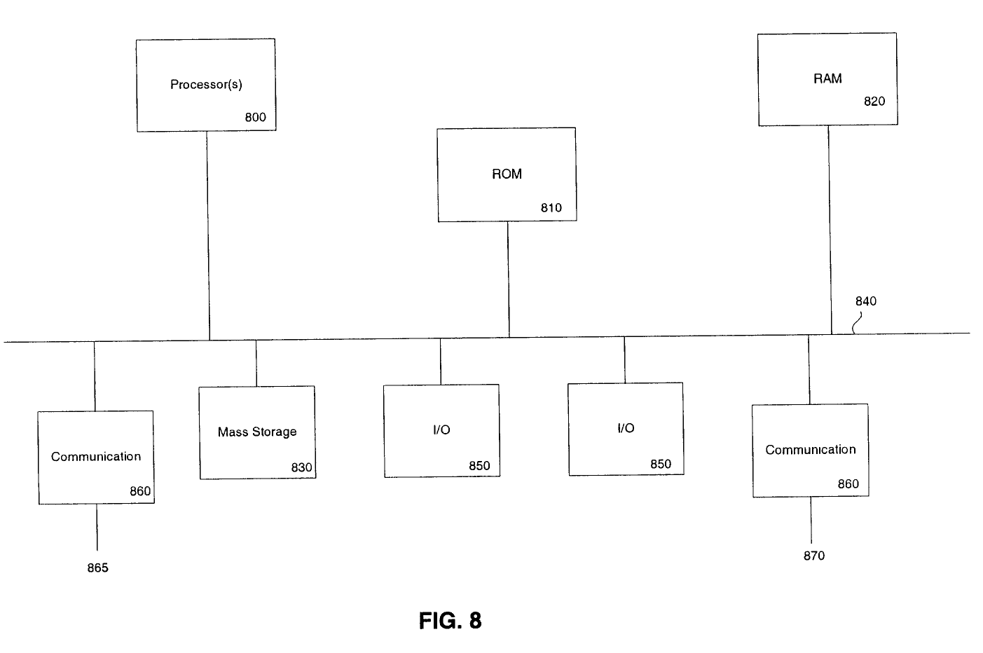

The physical processing platforms which embody the tracking engine and the tracking system may include processing systems such as conventional personal computers (PCs) and/or server-class computer systems according to various embodiments of the invention. FIG. 8 illustrates an example of such a processing system at a high level. The processing system of FIG. 8 may include one or more processors 800, read-only memory (ROM) 810, random access memory (RAM) 820, and a mass storage device 830 coupled to each other on a bus system 840. The bus system 840 may include one or more buses connected to each other through various bridges, controllers and/or adapters, which are well known in the art. For example, the bus system 840 may include a ‘system bus’, which may be connected through an adapter to one or more expansion, such as a peripheral component interconnect (PCI) bus or an extended industry standard architecture (EISA) bus. Also coupled to the bus system 840 may be the mass storage device 830, one or more input/output (I/O) devices 850 and one or more data communication devices 860 to communicate with remote processing systems via one or more communication links 865 and 870, respectively. The I/O devices 850 may include, for example, any one or more of a display device, a keyboard, a pointing device (e.g., mouse, touchpad, trackball), an audio speaker.

The processor(s) 800 may include one or more conventional general-purpose or special-purpose programmable microprocessors, digital signal processors (DSPs), application specific integrated circuits (ASICs), or programmable logic devices (PLD), or a combination of such devices. The mass storage device 830 may include any one or more devices suitable for storing large volumes of data in a non-volatile manner, such as magnetic disk or tape, magneto-optical storage device, or any of various types of Digital Video Disk (DVD) or Compact Disk (CD) based storage or a combination of such devices. The data communication device(s) 860 each may be any devices suitable for enabling the processing system to communicate data with a remote processing system over a data communication link, such as a wireless transceiver or a conventional telephone modem, a wireless modem, an Integrated Services Digital Network (ISDN) adapter, a Digital Subscriber Line (DSL) modem, a cable modem, a satellite transceiver, an Ethernet adapter, or the like.

Methodology

As stated above the tracking system includes the tracking engine and the tracking manager. The tracking engine discovers information about assets present in the network and submits the discovered data to the tracking manager, which in turn, evaluates, correlates and maintains the discovered data. The function of the tracking manager, the tracking engine and the interaction between the components are described in detail below.

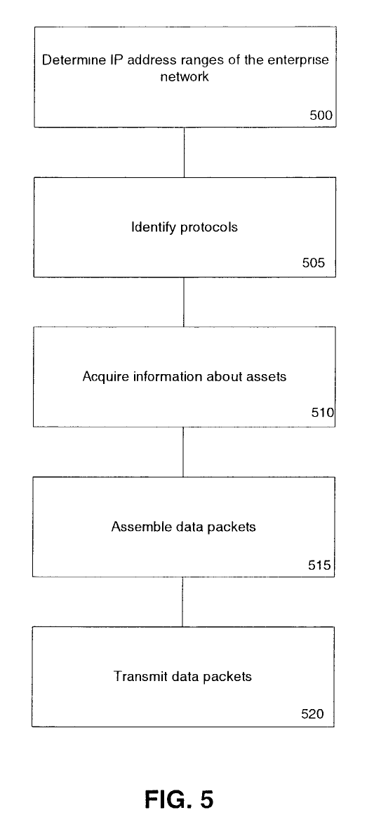

With these concepts in mind an embodiment of the present invention can be further explored with reference to FIG. 5. FIG. 5 shows an IT asset discovery process performed by the tracking engine 410. At 500 the tracking engine 410 determines Internet Protocol (IP) address ranges present in the enterprise network. The IP address ranges may be specified by an enterprise network operator during configuration of the tracking system. In addition, the IP address ranges may be obtained from an IP address management product or a NetWare Management System (NMS) product, which are well known in the art and do not require any further explanation. The defined IP address ranges may be stored in a database to be utilized by the tracking engine. Alternatively, the defined IP ranges may be stored on the tracking manager 430 and supplied to the tracking engine 410 upon request. The tracking manager 430 is described in detail below. Upon determining IP address ranges present in the enterprise network, the tracking engine 410 pings every IP address in the defined IP address ranges. In one embodiment, the tracking engine 410 pings IP addresses according to a predefined schedule. The schedule is maintained by a tracking manager 430 according to defined enterprise specifications. The tracking engine 410 periodically queries the tracking manager 430 to determine whether the pinging should be started. Personal computers may be pinged more often, because they are more mobile than server computers. Networks in particular geographical areas may be pinged at a predefined time period to ensure that no additional network traffic is added during time periods when the network is utilized the most.

At 505 upon determining which assets are connected to the network and are active, i.e. turned on, the tracking engine 410 identifies protocol stack used by each active asset. Upon identifying the protocol stack, the tracking engine 410 correlates the stack to the operating system being executed by the asset. This is known as Operating System fingerprinting, which is well known in the art and does not require any further explanation. The tracking engine 410 utilizes operating system (OS) fingerprinting to determine operating systems that are being executed on particular IT assets. For example, an asset can be executing Windows 2000 operating system, IOS 11.1 operating system or Solaris 9.0 operating system. Determination of an operating system running on a particular IT asset allows the tracking engine to select an appropriate protocol to be used in communications with the IT asset. OS identification allows the tracking engine 410 to determine if a discovered asset supports Microsoft protocols, such as NetBios and Windows Management Instrumentation (WMI). WMI protocol allows the tracking engine to gather detailed hardware and software information about personal computers, including portable computers and server computers. Identification of an operating system allows the tracking manager 430 to identify the vendor by utilizing enterprise-defined rules. For example, the enterprise-defined rules may state that all the assets that run Windows operating system are Personal Computers manufactured by Dell Computer Corporation (Round Rock, Tex.).

Upon completion of OS fingerprinting, the tracking engine 410 transmits SNMP requests to active assets to determine whether the assets are SNMP-enabled. Assets that respond to the requests are SNMP-enabled assets. SNMP-enabled devices allow the tracking engine 410 to discover information such as product type, serial number of the device, Internetwork Operating System (IOS) version, number and type of network cards by utilizing data stored in MIBs of SNMP-enabled devices.

Upon determining which assets are SNMP-enabled, the tracking engine at 510 utilizes the SNMP protocol to acquire information about the SNMP enabled assets, such as serial number, MAC address, host name, system name, hardware serial number, Basic Input/Output System (BIOS) serial number, and software application details which are stored in MIB objects. At 515 the tracking engine 410 assembles data packets containing discovered information about network assets. The data packets then are transmitted at 520 to the tracking manager in order to update status of the assets or add newly discovered network assets. In one embodiment the tracking engine 410 transmits data packets upon discovering a predetermined number of assets. In another embodiment the tracking engine transmits the packets according to a predetermined packet transmission schedule.

In one embodiment the tracking engine 410 utilizes SNMP-enabled assets to indirectly discover information about non-SNMP-enabled assets. SNMP-enabled assets maintain an information cache, called Address Resolution Protocol (ARP) cache, including information about assets that utilized services provided by an SNMP-enabled asset or communicated with an SNMP-enabled asset. For example, a PC user that used an SNMP enabled printer will cause the PC's IP address and MAC address to be placed in the information cache of the SNMP enabled printer.

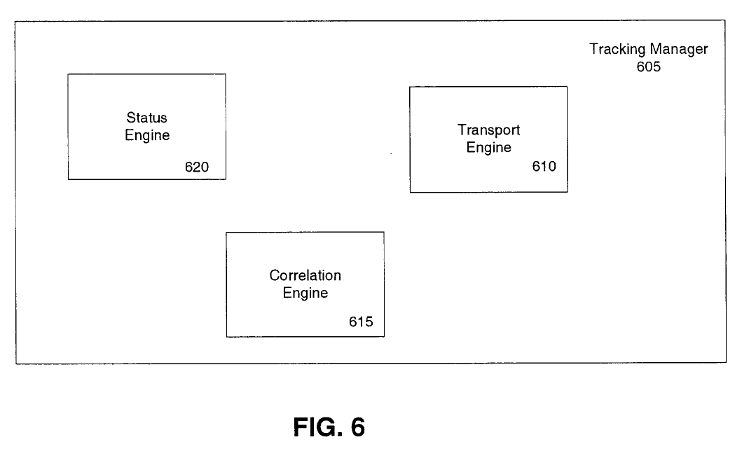

In one embodiment upon receiving a packet from a tracking engine the tracking manager 605, components of which are illustrated in FIG. 6, invokes the transport engine 610 in order to authenticate the tracking engine that sent the data packet. Communications between tracking engines and the tracking manager 605 may be secured via a secure protocol, such as Secure HyperText Transfer Protocol (HTTPS) channel.

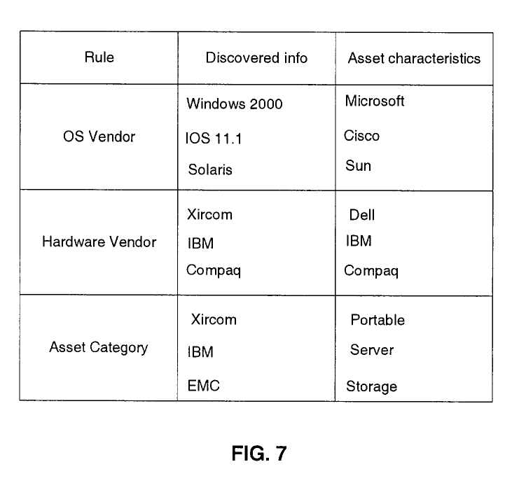

Upon successful authentication of the tracking engine transmitting a data packet, the tracking manager 605 utilizes enterprise created interference rules to derive more information from the discovered data. The enterprise created interference rules define correlations between discovered data and asset characteristics. For example, the enterprise created rules may define asset categorization rules, system vendor identification rules, hardware vendor identification rules, unique asset identification rules, product model number, product stocking identifier, and produce service indication messages. Asset categorization rules may specify hardware components that may be present only in particular asset categories. For example, a discovered asset which MAC address indicates that it includes a hardware component manufactured by Dell Computer Corporation, may be specified by the enterprise rules to be a laptop. In one embodiment the enterprise created rules may specify asset category based on discovered network interface card vendor, which is determined utilizing MAC address. FIG. 7 illustrates exemplary enterprise created rules. For example, the enterprise created rules may specify that if an asset comprises a MAC address that belongs to Xircom Corporation of Thousand Oak, Calif., then that asset is manufactured by Dell Computer Corporation. In one embodiment the enterprise created rules specify vendors of hardware components with particular MAC addresses. For example, the enterprise created rules may specify a range of MAC addresses belonging to each vendor that may be found in the network. Vendor specific MAC addresses may be found on Institute of Electrical and Electronics Engineers (IEEE) web site.

Upon determining asset information utilizing the enterprise created rules, the transport engine 610 invokes the correlation engine 615 in order to correlate the received data with the correct IT asset stored in the discovered assets database 310 or create a new entry for a newly discovered asset. The correlation engine 615 ensures that there is only one record maintained per each asset even if configuration of the asset has changed. For example, a laptop may include hardware components that have different MAC addresses, such as different network interface cards. If the received MAC address does not match to any MAC address stored in the database, the tracking manager may utilize other discovered data received for the asset to correlate the received data to an asset present in the database.

In one embodiment the correlation engine 615 correlates the received data to the database data by utilizing MAC addresses. If a received packet includes a MAC address, the correlation engine 615 locates the same MAC address in the discovered assets database 310 and determines whether a record of the asset with this particular MAC address needs to be updated. In one embodiment the correlation engine 615 records the date when the particular asset was discovered in order to ensure that the tracking system can identify assets that have not been connected to the enterprise network for a predetermined number of days.

If the packet does not comprise a MAC address, the correlation engine 615 retrieves the next field and locates the asset record in the discovered assets database 310 which corresponds to the received field in order to determine if any information needs to be updated. In one embodiment the correlation engine utilizes a field priority list in order to locate an appropriate asset entry for the received packet. For example, the correlation engine may utilize the received information to determine which asset records need to be updated in the following order: Motherboard serial number, BIOS serial number, computer serial number, MAC address, asset tag number, computer name, DNS name. It will be noted that this is an exemplary list and other priority lists may be utilized.

In one embodiment the correlation engine 615 maintains a connection status for discovered assets. For example, if a particular asset was not discovered for a predetermined time interval, the correlation engine notes such information in the discovered assets database 310. Such information allows the enterprise network operators to determine which assets were not connected to the network for a specific duration.

In one embodiment the status engine 620 maintains status information of assets discovered in the enterprise network. For example, if a particular asset was not connected to the network and has been inactive for a predetermined continuous period of time, the status engine 620 places the information about the asset in the lost assets database 330. It will be appreciated that the status information may also be stored in the discovered assets database. The status engine 620 determines continuous inactive dates of a particular asset, location changes of an asset, or any other status changes that may occur as specified by the enterprise rule s. The status engine 620 utilizes information compiled by the correlation engine 615 to maintain status information that may be stored in a separate database or in the discovered assets database 310. The status engine 620 determines a list of servers that came off network during a specified time interval and can be redeployed and stores the list in a database. The status engine 620 can also maintain the vendor-based assets database 320 that includes a list of all assets and components from a particular vendor that are present in the enterprise networks. Again, this information may be stored in the discovered assets database 310. The status engine 620 maintains the unauthorized assets database 335 comprising a list of unauthorized assets, such as wireless gateways, present in the network. The unauthorized assets are identified by the tracking manager by utilizing predefined enterprise rules specifying assets that are not authorized to be present in the network. In addition, the status engine 620 may include information such as assets manufactured by unauthorized vendors in the unauthorized assets database 335. The authorized vendor list and authorized assets list can be provided by the enterprise network operators. The status engine 620 may also compile a list of assets that have been moved out of a specified state for tax liability reduction. In addition, the status engine 620 may maintain a list of routers which had cards removed during a specified time interval, e.g. last month.

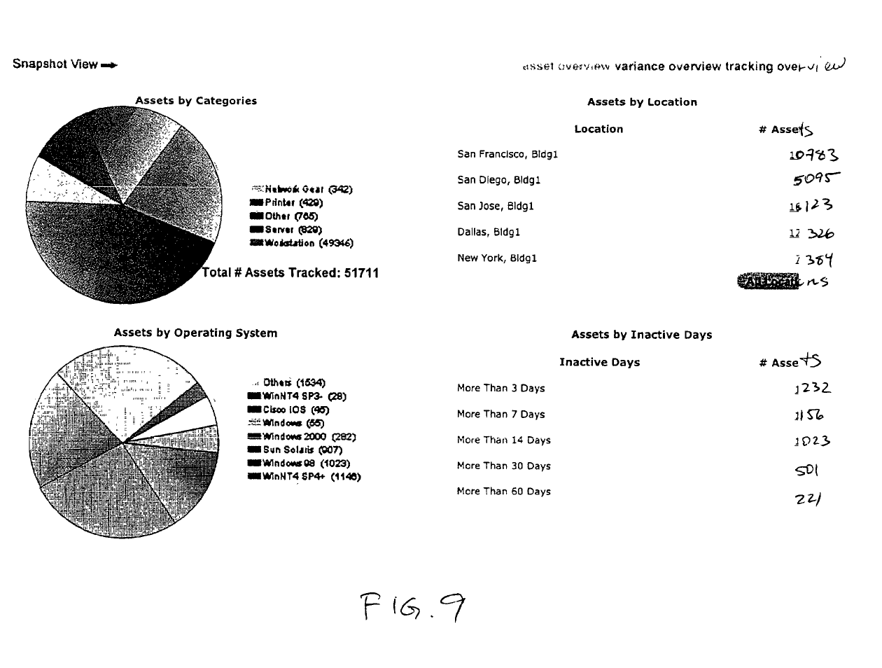

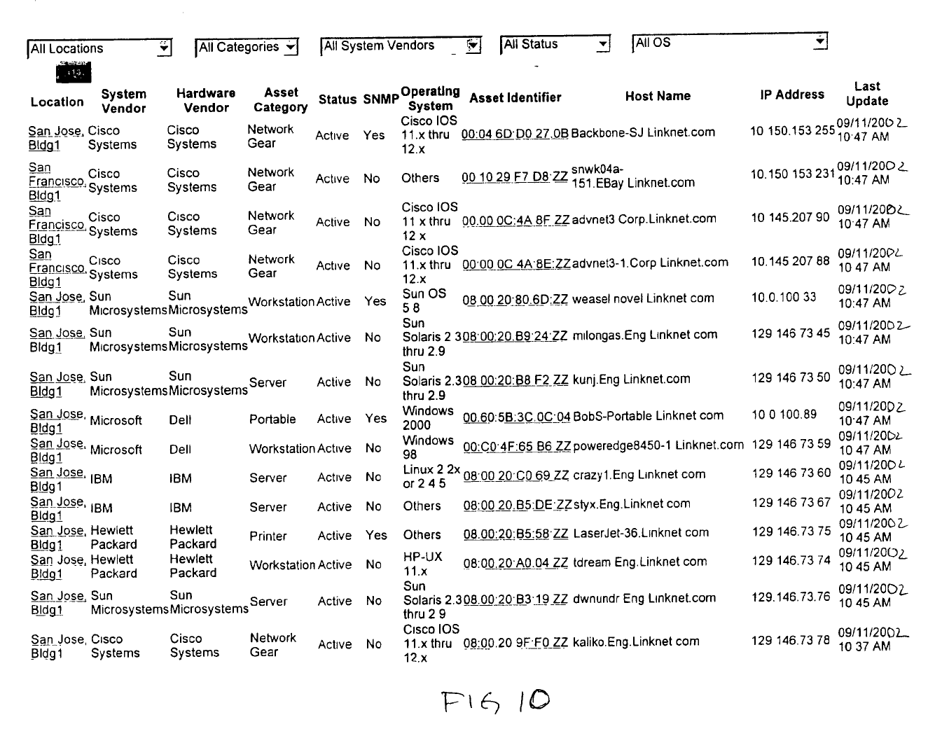

In one embodiment the status engine 620 may compile a status report upon request of one of the monitoring applications 215. The monitoring applications 215 may include enterprise applications utilized by the enterprise network operators in IT asset management. For example, a monitoring application may request a list of all the assets containing hardware components of a specified vendor. The monitoring application may also request the status engine 620 to compile a list of all the assets connected to the network on a specified date. It will be appreciated that a variety of status reports that can be generated by the status engine is not limited to the status reports described above. It will further be appreciated that the status engine may not maintain all the databases described above and generate particular status information only upon request issued by the monitoring applications 215. FIGS. 9 and 10 illustrate exemplary reports that may be generated by the status engine 620.

It will be recognized that many of the features and techniques described above may be implemented in software. For example, the described operations may be carried out in a processing system in response to its processor(s) executing sequences of instructions contained in memory of the device. The instructions may be executed from a memory such as RAM and may be loaded from a persistent store, such as a mass storage device, and/or from one or more other remote processing systems. Likewise, hardwired circuitry may be used in place of software, or in combination with software, to implement the features described herein. Thus, the present invention is not limited to any specific combination of hardware circuitry and software, nor to any particular source of software executed by the processing systems.

Thus, a method and apparatus for tracking IT assets in a network have been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative sense rather than a restrictive sense.

What is claimed is:

1. A method comprising:
discovering information about assets connected to a network utilizing protocols compatible with the assets;
transmitting the discovered information; and
maintaining status data for the assets based on the discovered information.

2. The method of claim 1 wherein the discovering information about the assets includes pinging predefined ranges of IP addresses present in the network.

3. The method of claim 2 wherein the pinging of the IP addresses is performed according to a predetermined schedule.

4. The method of claim 1 wherein the discovering information about the assets includes determining active network assets connected to the network.

5. The method of claim 1 wherein the discovering information about the assets includes identifying SNMP-enabled devices.

6. The method of claim 1 wherein the discovering information about the assets includes fingerprinting operating systems of the assets.

7. The method of claim 1 wherein the discovering information about the assets includes indirectly discovering information about assets by inspecting an information cache of SNMP-enabled assets.

8. The method of claim 1 wherein the maintaining status data for the assets includes correlating the received data to data stored in databases.

9. The method of claim 1 wherein the maintaining status data for the assets includes identifying assets that are inactive for a predetermined continuous period of time.

10. The method of claim 1 wherein the maintaining status data for the assets includes identifying a vendor of a discovered asset.

11. The method of claim 1 wherein the maintaining status data includes identifying a discovered asset utilizing the received discovered information.

12. The method of claim 1 further comprising generating a status report requested by a monitoring application.

13. The method of claim 1 wherein the maintaining status data includes utilizing a set of inference rules.

14. A method comprising:
receiving values of a plurality of parameters of a discovered asset in a network;
correlating at least one parameter value to an existing entry in an asset database, the entry including the plurality of parameters; and
updating the entry if the values of the plurality of parameters differ from values of the entry.

15. The method of claim 14 wherein the plurality of parameters includes a MAC address of the discovered asset.

16. The method of claim 14 wherein the plurality of parameters includes a serial number of the discovered asset.

17. The method of claim 14 further comprising utilizing a set of inference rules.

18. An apparatus comprising:
a tracking engine to discover information about assets connected to a network utilizing protocols compatible with the assets and to transmit the discovered information to a tracking manager; and
the tracking manager to identify the assets utilizing the discovered information and a predefined set of rules.

19. The apparatus of claim 18 wherein the tracking engine is located on a subnet of the network.

20. The apparatus of claim 18 wherein the tracking manager is located on a main network of the network.

21. The apparatus of claim 18 wherein the tracking engine further configured to ping predefined ranges of IP addresses present in the network.

22. The apparatus of claim 18 wherein the tracking engine further configured to identify SNMP-enabled assets.

23. The apparatus of claim 18 wherein the tracking engine further configured to indirectly discover information about assets utilizing an information cache of SNMP-enabled assets.

24. The apparatus of claim 18 wherein the discovered information is a MAC address.

25. The apparatus of claim 18 wherein the tracking manager further configured to correlate the received discovered information to an information present in databases.

26. The apparatus of claim 18 wherein the tracking manager further to identify assets that are inactive for a predetermined continuous period of time.

27. The apparatus of claim 18 wherein the tracking manager further configured to generate a status report requested by a monitoring application.

28. An apparatus comprising:
means for discovering information about assets connected to a network utilizing protocols compatible with the assets;
means for transmitting the discovered information; and
means for maintaining status data for the assets based on the discovered information.

29. A processing system comprising:
a processor; and
a storage medium having stored therein instructions which, when executed by the processor, cause the processing system to perform a method comprising:
discovering information about assets connected to a network utilizing protocols compatible with the assets;
transmitting the discovered information; and
maintaining status data for the assets based on the discovered information.

30. The processing system of claim 29 wherein the discovering information about the assets includes pinging predefined ranges of IP addresses present in the network.

31. The processing system of claim 30 wherein the pinging of the IP addresses is performed according to a predetermined schedule.

32. The processing system of claim 29 wherein the discovering information about the assets includes determining active network assets connected to the network.
